(19) United States
(12) Patent Application Publication
(10) Pub. No.: US 2005/0238563 A1
(43) Pub. Date: Oct. 27, 2005

(54) Method for sequestering carbon dioxide

(76) Inventors: T. Taylor Eighmy, Lee, NH (US); Kevin H. Gardner, Newmarket, NH (US); Thomas Seager, Lafayette, IN (US)

Correspondence Address: Devine, Millimet & Branch, P.A., 111 Amherst Street, Manchester, NH, 03101, US

(21) Appl. No.: 11/075,617

(22) Filed: Mar. 8, 2005

Related U.S. Application Data
(60) Provisional application No. 60/551,197, filed on Mar. 8, 2004.

(51) Int. Cl. C01F 11/18

(52) U.S. Cl. 423/432

(57) ABSTRACT

A method for permanently sequestering CO₂ by bringing a gas containing the CO₂, which may be the atmosphere, into contact with alkaline waste materials containing Ca to form a carbonate that is stable and environmentally benign.

### CROSS-REFERENCE TO RELATED APPLICATIONS

The present application claims the benefit of provisional patent application Ser. No. 60/551,197 filed Mar. 8, 2004, which is incorporated herein by reference.

### FIELD OF THE INVENTION

The present invention relates generally to a method of sequestering carbon dioxide. More particularly, it relates to a method of using alkaline waste materials for sequestering carbon dioxide.

### BACKGROUND OF THE INVENTION

Carbon Dioxide (“CO₂”) is a greenhouse gas, the atmospheric concentration of which has been increasing over the last century. In addition, the amounts of CO₂ being emitted into the atmosphere annually show a steady increase over the past 50 years.

There are many sources of CO₂ emissions. Approximately one-third of the total emissions (3.05×10⁹ tons in 2000) in the United States is from coal fired power plants, oil refineries, cement kilns, municipal solid waste incinerators, and other large point sources. Another one-third of the total emissions in the United States is from cars, trucks and other vehicles.

A number of methods have been suggested for reducing CO₂ emissions from large point sources. For example, U.S. Patent Publication No. 2004/0228788, describes a method for subjecting flue gas to gas-liquid contact with coal ash water slurry or coal ash eluate to make the CO₂ in the flue gas react and be absorbed, thereby fixating the CO₂ as carbonate. These methods are generally complicated and not cost effective.

Because of the large number of, and the smaller emissions from, vehicles and other individually smaller sources of CO₂, cost effective suggestions for reducing CO₂ emissions from these sources have been scarce. Rather, a number of methods have been suggested for removing atmospheric CO₂. These methods include: (1) deep ocean injection of CO₂; (2) enhanced oil recovery through injection of CO₂ into an oil reservoir; (3) enhanced fertilization of forests and oceans to increase the uptake of CO₂ by flora, including algae and phytoplankton; (4) injection of CO₂ into geologic formations and (5) carbonation of naturally occurring olivine (Mg₂SiO₄) and serpentine (Mg₃Si₂O₅(OH)₄). However, each of these methods has drawbacks when measured against the criteria of permanent CO₂ sequestration, cost effectiveness, and additional environmental benefits.

Accordingly, the present invention is a method for, in one step, removing CO₂ from the atmosphere or a gas flow which has a higher concentration of CO₂ and storing it. It involves the carbonation of alkaline waste materials containing Ca-bearing phases, which would otherwise be placed in landfills, permanently to sequester CO₂.

### SUMMARY OF THE INVENTION

The present invention is a method of sequestering CO₂ by bringing it into contact with alkaline waste material containing Ca. The CO₂ reacts with the Ca in the alkaline waste material to form a carbonate, as illustrated in this example reaction:
Ca(OH)₂+CO₂ [symbol] CaCO₃+H₂O
thereby permanently sequestering the CO₂.

It is an object of the present invention permanently to sequester CO₂.

It is a further object of the present invention to combine the steps to remove CO₂ from the atmosphere or a gas flow having a higher concentration of CO₂ and permanently to sequester the CO₂.

It is a still further object of the present invention more cost effectively permanently to sequester CO₂.

It is a still further object of the present invention permanently to sequester CO₂ and to provide additional environmental benefits, including using alkaline waste materials, thereby saving landfill space.

### BRIEF DESCRIPTION OF THE DRAWINGS

These and other features and advantages of the present invention will be better understood by reading the following detailed description, taken together with the drawings wherein:

FIG. 1 is a table of properties of certain preferred alkaline waste materials;

FIG. 2 is a schematic diagram of an experimental apparatus;

FIG. 3 is a bar chart showing CO₂ removal capabilities for certain materials;

FIG. 4 is a graph plotting CO₂ removal versus time with different gas humidity conditions;

FIG. 5 is a thermogravimetric analysis of CKD (cement kiln dust) carbonated for one month with different gas humidity conditions;

FIG. 6 is a scanning electron microscope image of unreacted class C CFA (coal fly ash);

FIG. 7 is a scanning electron microscope image of reacted class C CFA (coal fly ash);

FIG. 8 is an x-ray photoelectron spectroscopy analysis of unreacted and reacted class C CFA (coal fly ash);

FIG. 9 is an x-ray diffraction analysis of unreacted and reacted class C CFA (coal fly ash); and

FIG. 10 is a cross-section of a roadside embankment embodying the method of the present invention.

### DETAILED DESCRIPTION OF THE INVENTION

The present invention is a method of permanently sequestering CO₂ by bringing the gas containing the CO₂, which may be the atmosphere, into contact with alkaline waste materials containing Ca. The CO₂ reacts with the Ca to form a carbonate as follows:
Ca(OH)₂+CO₂ [symbol] CaCO₃+H₂O
CaCO₃ is a stable and environmentally benign material, and the CO₂ is permanently sequestered.

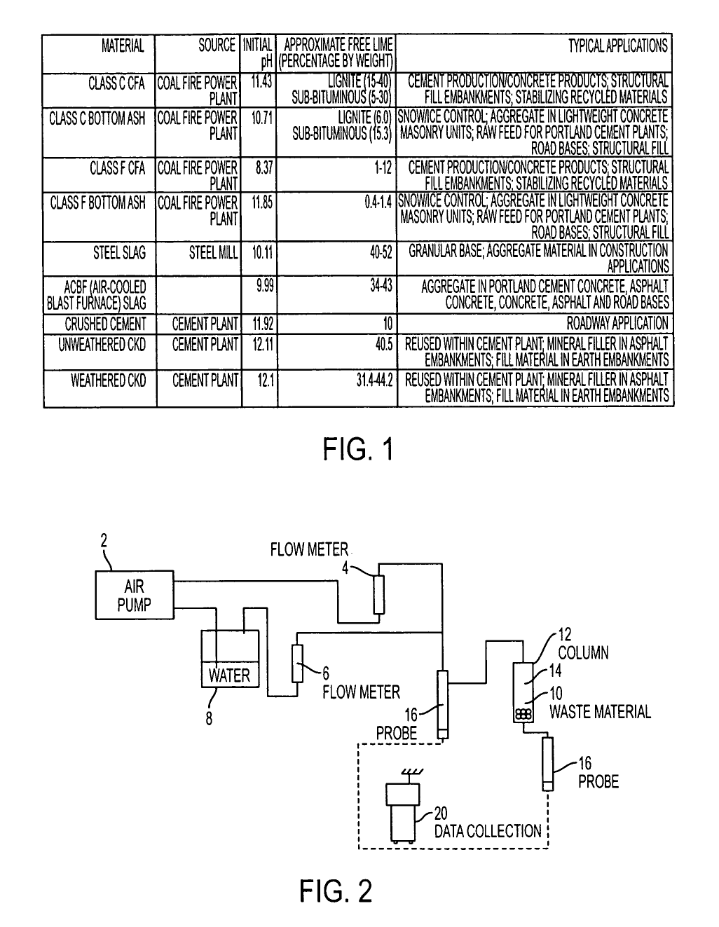

The method of the present invention will work with any alkaline waste materials containing Ca, which may be present as CaO, Ca(OH)₂, and other CA-bearing solid phases. Waste materials are generally the by products of other processes such as combustion residue, mining tailings, crushed concrete and red mud from bauxite processing. Examples of such alkaline waste materials that are preferred include, but are not limited to: (1) class C CFA (coal fly ash); (2) class C bottom ash; (3) class F CFA (coal fly ash); (4) class F bottom ash; (5) steel slag; (6) ACBF (air-cooled blast furnace) slag; (7) crushed concrete; (8) unweathered CKD (cement kiln dust); and (9) weathered CKD (cement kiln dust). Certain properties of these alkaline waste materials are shown in FIG. 1.

In preferred embodiments of the present invention that will be used for atmospheric CO₂, the alkaline waste materials will be exposed to ambient temperature and pressure. Thus, lab experiments were designed to replicate the full scale design environment as closely as possible. This was accomplished by pumping a controlled air flow rate through a column containing waste materials at room temperature and atmospheric pressure. A schematic diagram of the laboratory apparatus used is shown in FIG. 2. The air source 2 into the system was a compressed air pump (or a tank of pure CO₂). The CO₂ containing gas could be directed through flow meter 4 at ambient humidity or through flow meter 6 after having been humidified by humidification system 8. The alkaline waste material 10 was placed at the bottom of the column 12 and glass wool 14 was placed above the waste material 10 to ensure that particulate matter did not escape during the experiment. A Viasala GM70 CO₂ probe 16 was used to read the levels of CO₂ in the gas before passing through the column 10 and after passing through the column 10.

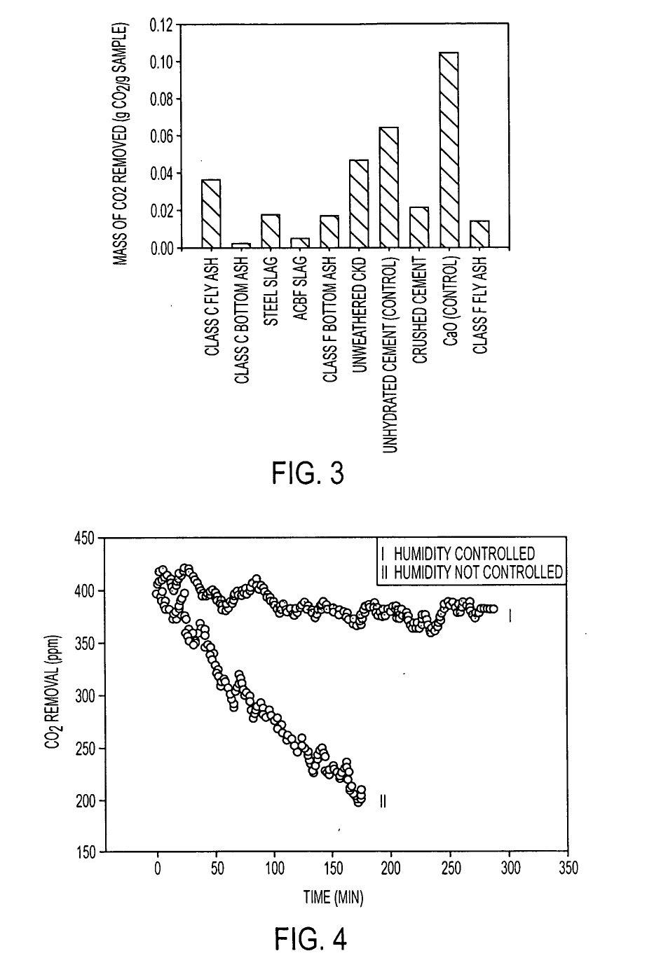

Experiments were conducting using eight of the nine preferred alkaline waste materials described above excluding weathered CKD (cement kiln dust). Ca and unhydrated cement were run as controls with known theoretical uptake capacities for CO₂. Ten grams of each material were placed in the glass column 12 in the apparatus shown in FIG. 2 and exposed to air (with a constant CO₂ concentration) at atmospheric pressure and at ambient temperature and humidity at a flow rate of 1 SCFH for 24 hours. During this time, the CO₂ concentrations in the air leaving the column were recorded every minute. This data was used to perform a mass balance on the CO₂ in the air before and after contacting the material. The 24-hour CO₂ removal capability for each material used in the column test is presented in a bar chart shown in FIG. 3.

In a preferred embodiment of the present invention, the choice of alkaline waste material containing Ca will depend not only on its capacity to remove CO₂ but also on its cost, including its initial cost, the cost of transporting it to the site where it will be used, and the cost of recycling or disposing of it after its use.

In preferred embodiments of the present invention, the relative humidity of the gas containing the CO₂, and the moisture content of the alkaline waste material may be adjusted. The reaction of the CO₂ with the Ca in the alkaline waste material proceed under ambient pressure and temperature conditions, and with the humidity of atmospheric CO₂. Increasing the relative humidity of the gas containing the CO₂ or the moisture content of the alkaline waste material may optimize reaction rates.

The apparatus shown in FIG. 2 was again used to test the reaction rate for atmospheric CO₂ under ambient pressure and temperature. Atmospheric gas at ambient temperature, pressure, and CO₂ partial pressure was introduced to columns containing waste materials. Gas humidity was controlled by two flow meters 4, 6, in one of which 6 gas was passed through a humidification system 8, and in one of which 4 ambient air was used. The CO₂ concentration was monitored before and after contact with the waste material using probes 16. The data from these probes was stored in a data recorder 20 and later downloaded into a computer for analysis.

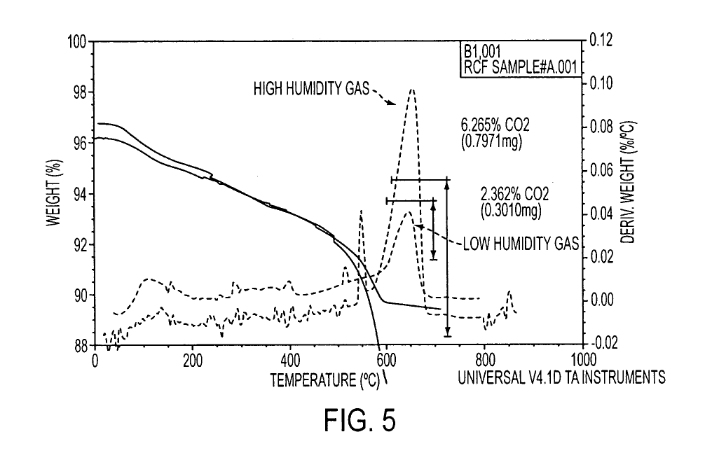

Typical results of the experiments to investigate reaction kinetics of various recycled materials are shown in FIG. 4. A high moisture sample (13% moisture content in the crushed cement and an 85% humidity gas stream) and a low moisture sample (ambient moisture content of ˜2% in crushed concrete and ambient humidity of ˜10%). The low moisture sample initially shows about the same carbonation in the first minutes of the experiment. But, the uptake of CO₂ quickly is diminished over a couple of hours. The high moisture sample, on the contrary, demonstrates consistent CO₂ removal over the time frame of this experiment. In addition to these short studies, longer-term studies were performed as well. Two columns were run for 1 month each. They were both begun with initial moisture content in the waste material of 15%, a flow rate of 2.5 standard cubic feet per hour, and with atmospheric concentration of CO₂. However, the humidity was varied between low (˜10%) and high (˜95%). The column run under higher relative humidity absorbed a much higher amount of CO₂ than its counterpart. Thermogravimetric analysis (TGA) of these samples showed that the column with high humidity absorbed approximately 6% of its weight in CO₂, while the other only absorbed approximately 2% of its weight. These TGA results are shown in FIG. 5. Thus, increasing the moisture content of the waste material and the relative humidity of the CO₂ containing gas leads to more effective CO₂ removal. However, in a preferred embodiment of the present invention, other factors affecting both the cost of humidifying the gas containing the CO₂ and the cost of increasing the moisture content of the alkaline waste material will enter the choice of the levels of humidity and moisture content.

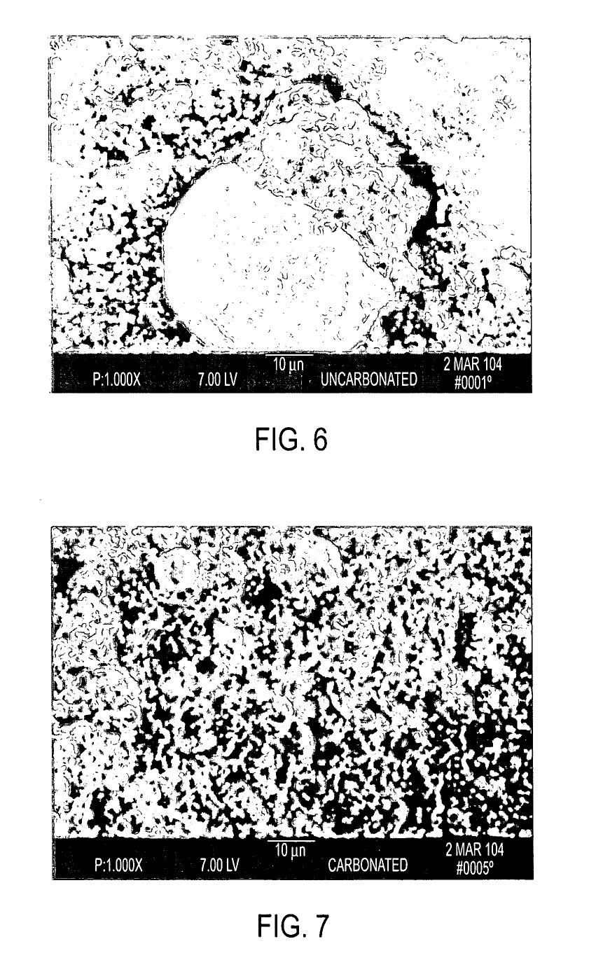

In addition, in order to confirm the reaction occurring in the present invention, reaction products have been characterized using a number of techniques. Scanning electron microscopy (SEM), x-ray diffraction (XRD) and x-ray photoelectron spectroscopy (XPS) all confirm the presence of CaCO₃, commonly referred to as calcite, in reacted samples. SEM analyses clearly show the presence of calcite reaction products on the surfaces of class C CFA (coal fly ash) particles. In unreacted class C CFA (coal fly ash), as shown in FIG. 6, spherical amorphous particles are present with very little microcrystalline features on or around the particles. In reacted class C CFA (coal fly ash), as shown in FIG. 7, extensive microcrystalline structures characteristic of CaCO₃ are seen on, and adjacent to, the spherical particles.

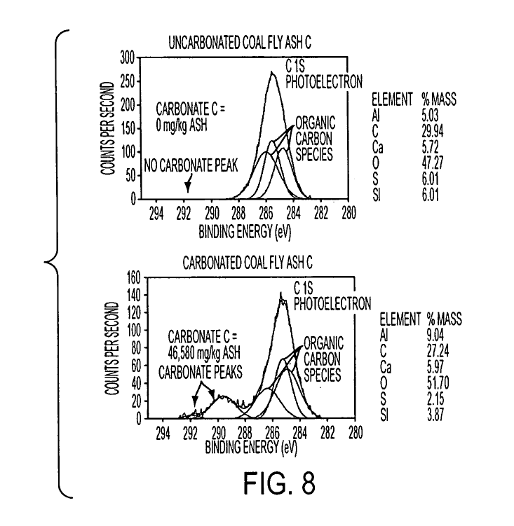

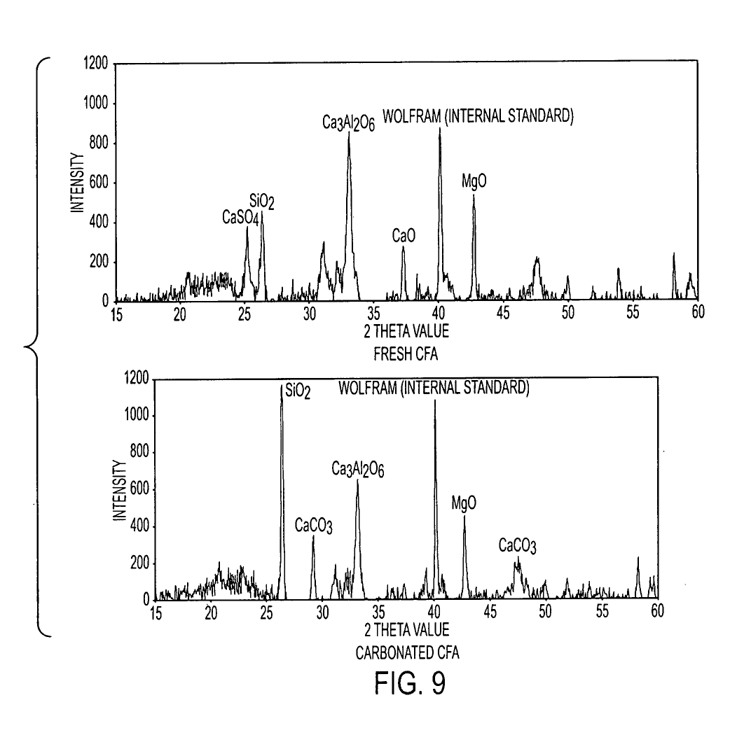

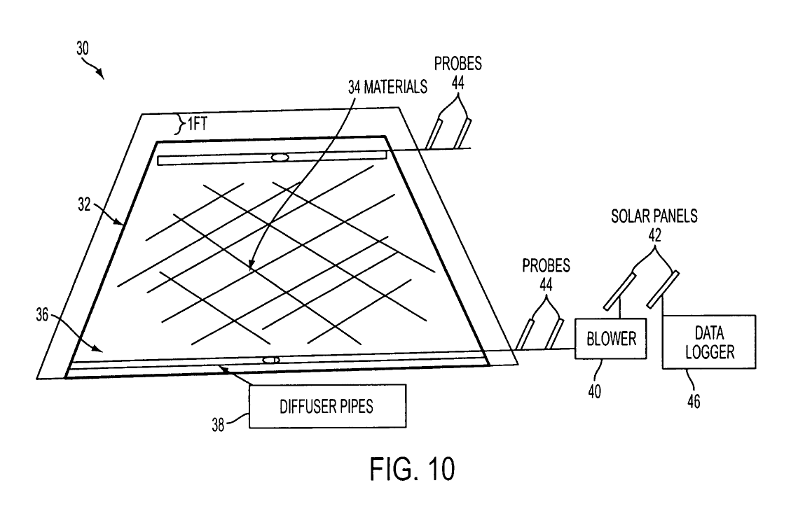

XPS, as shown in FIG. 8, has also confirmed the presence of CaCO₃ in the reacted samples, suggesting sequestration of CO₂ in a stable form under ambient conditions. X-ray diffraction analysis was conducted on class C CFA (coal fly ash) samples before and after the reaction of the present invention as well. For the unreacted sample, CaO peaks are clearly present. CaO peeks are absent in the reacted sample in which sample CaCO₃ peaks are also present, as shown in the alkaline waste material and in FIG. 9. These analyses indicate the CO₂ has reacted with the CaO in the alkaline waste material and has been converted to CaCO₃.

This confirms that the general reaction can be described as follows:
Ca(OH)₂+CO₂ [symbol] CaCO₃+H₂O.

One of the preferred embodiments of the present invention is the sequestration of CO₂ under ambient conditions (atmospheric temperature, pressure and CO₂ partial pressure). The mechanical process of bringing atmospheric CO₂ in contact with alkaline waste material containing Ca in the preferred embodiment can generally be divided into two groups. The mechanical process in the first group use the alkaline waste materials only for sequestering the CO₂ prior to disposal of the waste material. The mechanical process in the second group use the waste material simultaneously as building material and for sequestering the CO₂.

One preferred embodiment in the first group is as simple as placing the alkaline waste material in numerous large outdoor piles. The piles can then be disturbed periodically so that atmospheric CO₂ can contact the Ca in the waste material and moisture in controlled amounts can be added. In another preferred embodiment in this group, a relatively thin layer of the alkaline waste material can be spread out, moisture content can be maintained, and periodically another such layer can be spread out on top of the last layer.

As to the second group, there are numerous ways in which the alkaline waste material can be used simultaneously as building material and for sequestering CO₂, such as sound barriers, embankments, roadways and parking lots. One such preferred embodiment is embodied in a roadside embankment. The roadside embankment will be constructed with 500 ft.-long sequestration cells and 100 ft.-long sequestration verification cells (“SVC”), as shown in cross-section in FIG. 12.

The SVC 30 and the sequestration cells will both have a geosynthetic 32 encasing the waste material 34. This will provide a degree of control over the amount of air flow going through the system to allow for effective monitoring and to provide protection from the release of contaminants into the environment. A four-inch layer of gravel 36 will protect the diffuser pipes 38 from being clogged by carbonate precipitates. Based on the compaction properties of the alkaline waste materials it may be necessary to amend it with gravel in order to create a more porous medium to facilitate airflow. In order to facilitate airflow through the system, a blower 40 powered by solar panels 42 will be used for every cell within the embankment. The influent and effluent diffuser pipes will be equipped with all-weather probes 44 for monitoring airflow and CO₂ concentration. This data will be recorded in a central data-logging unit 46.

In another preferred embodiment of the present invention, CO₂ from gas streams that have concentrations of CO₂ higher than atmospheric concentrations is sequestered. An example of the mechanism of bringing such a gas stream in contact with alkaline waste containing Ca includes, but is not limited to, flowing emissions from power plants or cement kilns through such alkaline waste materials.

While the principles of the present invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. A method for sequestering CO₂ comprising:
bringing a gas containing CO₂ into contact with an alkaline waste material containing Ca-bearing phases;
and allowing the CO₂ to react with the Ca to produce CaCO₃.

2. The method of claim 1 wherein the CO₂ has a concentration in the gas about equal to the concentration of CO₂ in the atmosphere.

3. The method of claim 1 wherein the CO₂ has a concentration in the gas greater than the concentration of CO₂ in the atmosphere.

4. The method of claim 1 wherein the gas containing CO₂ has a pressure, a temperature, and a CO₂ concentration equal to atmospheric pressure, temperature and CO₂ concentration, respectively.

5. A method for sequestering CO₂ comprising:
humidifying a gas containing CO₂;
adding water to an alkaline waste material containing Ca-bearing phases;
bringing the gas into contact with the waste material; and
allowing the CO₂ to react with the Ca to produce CaCO₃.

6. The method of claim 5 wherein the waste material comprises class C CFA (coal fly ash).

7. The method of claim 5 wherein the waste material comprises crushed concrete.

8. The method of claim 5 wherein the waste material comprises unweathered CKD (cement kiln dust).
